(19) United States
(12) Patent Application Publication
(10) Pub. No.: US 2024/0240759 A1
(43) Pub. Date: Jul. 18, 2024

(54) MULTI-CRYOGENIC STORAGE SYSTEM

(71) Applicant: MAGNA STEYR Fahrzeugtechnik GmbH & Co KG, Graz (AT)

(72) Inventor: Guido BARTLOK, Graz (AT)

(73) Assignee: MAGNA STEYR Fahrzeugtechnik GmbH & Co KG, Graz (AT)

(21) Appl. No.: 18/527,316

(22) Filed: Dec. 3, 2023

(30) Foreign Application Priority Data
Jan. 13, 2023 (EP) 23151487.8

(51) Int. Cl. F17C 7/02

(52) U.S. Cl. CPC F17C 7/02; F17C 2203/0391; F17C 2203/0629; F17C 2205/0134; F17C 2205/0335; F17C 2205/0352; F17C 2221/012; F17C 2223/0161; F17C 2227/015; F17C 2227/0348; F17C 2270/0168

(57) ABSTRACT

A multi-cryostorage system that includes at least two cryocontainers for storing hydrogen. The at least two cryocontainers are connected in hydraulic communication via a cryogenic connecting line, and include a primary storage system having a primary inner tank and a primary outer container, and at least one secondary storage system having a secondary inner tank and a secondary outer container. A heat exchanger is operable to heat the hydrogen, and at least one cryopump is arranged in the primary inner tank to supply unpressurised liquid hydrogen and/or unpressurised gaseous hydrogen in one or more stages at low temperature, to the heat exchanger for delivery to a consumer at a pressure higher than the pressure in the primary inner tank.

### CROSS-REFERENCE TO RELATED APPLICATIONS

The present application claims priority 35 U.S.C. § 119 to European Patent Publication No. EP 23151487.8 (filed on Jan. 23, 2023), which is hereby incorporated by reference in its complete entirety.

### TECHNICAL FIELD

One or more embodiments of the present disclosure relates to a multi-cryostorage system comprising at least two cryocontainers for storing hydrogen, in particular, as a mobile multi-cryostorage system for storing hydrogen to power a motor vehicle.

### BACKGROUND

It is known that mobile cryostorage systems are used to carry the hydrogen required to provide power in a motor vehicle.

There are also vehicles which have two tanks (double-tank arrangements) or a plurality of tanks (multi-tank arrangements), in particular when large amounts of fuel are needed and/or the geometrical installation space necessitates division into multiple storage containers of the same size or different sizes.

In general, mobile multiple liquid-hydrogen storage systems are designed so that the cryocontainers respectively are technically complete and function independently of one another. The cryocontainers in this case supply fuel to the same consumer together or respectively to separate consumers (for example fuel cell modules).

Multi-tank arrangements usually have various disadvantages. For example, if an essential component in a cryocontainer fails, the remaining amount of hydrogen generally remains unused in this storage unit so that the range of the vehicle is reduced. In the individual cryocontainers, the pressures in the inner tank must be higher than the supply pressure in the lines to the consumer. Should cryocontainers have, for example, different sizes, or different extraction takes place, different fuel levels, fuel temperatures and fuel pressures may be set up in the containers, with negative effects for example on subsequent filling.

### SUMMARY

One or more embodiments of the present disclosure provides multi-cryostorage systems of the aforementioned type, which reduce at least some of the aforementioned problems. In particular, one or more embodiments of the present disclosure provides a multi-cryostorage system comprising at least two cryocontainers for storing hydrogen, which economically makes it possible to minimize the operating pressure in the two/plurality of inner tanks.

In accordance with one or more embodiments of the present disclosure, a multi-cryostorage system comprises one or more of the following: at least two cryocontainers for storing hydrogen, namely a primary storage system having a primary inner tank and a primary outer container; and at least one secondary storage system having a secondary inner tank and a secondary outer container, wherein the two cryocontainers are connected in hydraulic communication via a cryogenic connecting line, wherein at least one cryopump is arranged in the primary inner tank of the cryocontainer of the primary storage system, which supplies liquid and/or gaseous hydrogen unpressurised and/or pressurized, in one or more stages and at very low temperature, to a heat exchanger, which warms the hydrogen and delivers it further to a consumer at a pressure higher than the pressure in the first inner tank.

Thus, the multi-cryostorage system in accordance with one or more embodiments has at least two cryocontainers, each having an inner tank and an outer container, an insulation space, in particular, a vacuum space arranged between the inner tank and the outer container. The two cryocontainers, in particular, the two inner containers, are connected in hydraulic communication, i.e., so as to convey fluid, via a cryogenic connecting line.

In accordance with the one or more embodiments, at least one cryopump is arranged in the inner tank of one of the cryocontainers, namely in the primary inner tank of the primary storage system. Liquid and/or gaseous hydrogen can be supplied by the cryopump at very low temperature to a heat exchanger, which warms the hydrogen and delivers it further to a consumer. The delivery to the consumer may in this case take place at a pressure which is higher than the pressure in the primary inner tank of the primary storage system.

By the use of the connecting line between the two inner tanks, a single cryopump in the primary storage system may be used for both cryocontainers. One cryopump is sufficient to deliver fuel from a plurality of cryocontainers to the consumer. With the combination of a cryopump and a connecting line, the operating pressure in the two/plurality of inner tanks may be minimized and may be less than the lowest possible supply pressure to the consumer. The device also allows mass transfer and optionally the equilibration of amounts of fuel during regular operation.

As used herein, the term “multi-cryostorage system” covers cryostorage systems which comprise at least two cryocontainers, i.e. including double-tank systems.

In accordance with the one or more embodiments, the cryopump is fully surrounded by cryogenic fluid during normal operation and/or the drive of the cryopump is adapted to work at very low temperatures. This allows a lower electrical power consumption for the cold gas compression.

In accordance with the one or more embodiments, the connecting line preferentially has at least one, preferably two check valves near to the tanks, which are adapted to allow hydraulic pressure equilibration and preferentially also to close the connection between the two inner tanks via the connecting line in the event of a leak, in order to isolate the two tanks from one another. The check valves near to the tanks may be arranged at the respective tank, preferentially respectively in the insulation space between the inner tank and the outer container. The combination of a connecting line and check valves on both sides allows a regulated release of compensating flows between the cryocontainers. This leads to pressure equilibration between the communicating inner tanks.

In accordance with the one or more embodiments, the connecting line has, preferentially downstream of the check valves near to the tanks, particularly preferentially, only line ends which are preferably routed in a region of the respective inner tank near to the bottom. The connecting line is preferably substantially a simple line which has no further components apart from the check valves. The connecting line is preferentially a line which is independent of extraction devices, such as extraction lines, of the two cryocontainers.

In accordance with the one or more embodiments, the primary storage system is adapted to return a partial flow of the warmed hydrogen, i.e., the extracted hydrogen downstream of the heat exchanger, via a return line into the primary inner tank in order to increase the inner tank pressure and preferentially maintain it at a minimum pressure. Preferably, a check valve for the gas return to the primary inner tank is arranged in the return line.

In accordance with the one or more embodiments, a pressure reducer, preferentially with a downstream pressure safety valve, is installed in the return line for the gas return to the primary inner tank. In this way, the pressure for the gas return into the primary inner tank may be limited.

In accordance with the one or more embodiments, a buffer container for warm hydrogen is arranged between the cryopump and the consumer. In this way, it is possible to compensate for a fluctuating delivery power of the cryopump possibly occurring.

In accordance with the one or more embodiments, the primary and secondary storage systems may preferably be filled separately via respective filling interfaces, i.e. each tank on its own.

In accordance with the one or more embodiments, one or more cryopumps are arranged only in the primary storage system. No cryopump is preferably arranged in the secondary storage system.

Overall, the secondary storage system preferentially comprises substantially the same components as the primary storage system, with the exception that no cryopump is arranged in the secondary storage system. In another preferred embodiment, at least one or more components which are provided for the pressure increase, extraction and/or conditioning of the hydrogen in the primary storage system are omitted in the secondary storage system, in particular a heat exchanger and/or an extraction line and/or one or more check valves in the extraction line. Costs, system weight and storage capacity may thereby be optimized.

### DRAWINGS

One or more embodiments of the present disclosure will be illustrated by way of example in the drawings and explained in the description hereinbelow.

FIG. 1 illustrates a schematic representation of a multi-cryostorage system, in accordance with one or more embodiments.

### DESCRIPTION

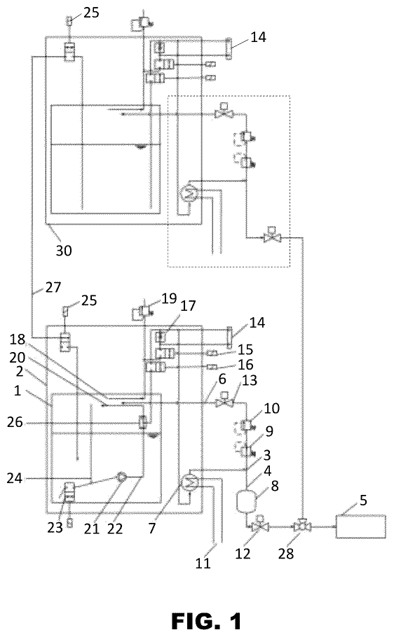

FIG. 1 represents a multi-cryostorage system in accordance with one or more embodiments, which comprises two cryocontainers, i.e., a so-called double-tank arrangement. A primary storage system (represented in the lower half of FIG. 1) comprises a primary inner tank 1 and a primary outer container 2, with an insulation space as an intermediate space between the primary inner tank 1 and the primary outer container 2.

The primary storage system can deliver gas and/or cryogenic liquid at very low temperature from the primary inner tank 1 via a power-controlled pressure-increasing cryopump 21, for example, via a pressure line 22 of the cryopump 21 which debouches at a line connection 3 into a supply line 4, to a consumer 5. Gas can be extracted from the primary inner tank 1 via a gas extraction line 24 as an extended intake port of the cryopump 21. Liquid can selectively be delivered from the primary inner tank 1 by the pump 21 through a check valve 23 near to the pump for switching from LH2 to GH2.

The cryopump 21 is preferably fully surrounded by cryogenic fluid, i.e. the drive of the pump 21 also works at very low temperatures, which allows a lower electrical power consumption for the cold gas compression.

From the primary inner tank 1 into the extraction line, furthermore, gas can flow by opening a GH2 tank valve 15 and/or liquid can flow by opening an LH2 tank valve 16. Gas may in this case be extracted from the primary inner tank 1 via a combined safety and gas extraction line 18. A nonreturn valve 17 for the gas extraction may be provided downstream of the GH2 tank valve 15. Gas may also be let out from the combined safety and gas extraction line 18 through a pressure relief safety valve 19.

Downstream of the extraction from the primary inner tank 1, in particular, downstream of the cryopump 21 and downstream of the tank valves 15, 16, the cryogenic fluid is fed through a heat exchanger 7 while being fully converted into the gas phase by supplying heat, preferably via cooling water 11 of the consumer 5, and at the same time is warmed sufficiently for the consumer 5. The cryopump 21 delivers the hydrogen on demand to the consumer 5 at a higher pressure than in the primary inner tank 1. The extraction of fuel from the primary storage system reduces the pressure and the amount of fuel in the primary inner tank 1 thereof.

In order to compensate for a fluctuating delivery power of the cryopump 21 possibly occurring, a buffer container 8 for warm hydrogen may additionally be arranged between the pump 21 and the consumer 5. A check valve 12 for the H2 supply to the consumer 5 may be arranged in the extraction line upstream of the consumer 5.

A secondary storage system 30 is connected in hydraulic communication to the primary storage system via a cryogenic connecting line 27. The connecting line 27 has check valves 25 near to the tanks, on each of the two cryocontainers, which on the one hand make it possible to control the hydraulic equilibration and on the other hand isolate the connecting line 27 and the inner tanks from one another in the event of a leak. The check valves 25 may be arranged in the respective insulation space. The connecting line 27 may be routed downwards downstream of the check valves 25 into the respective primary inner tank 1, into a region in which there is usually liquid hydrogen.

The primary secondary storage system and the secondary storage system can be filled separately via respective filling interfaces 14. The filling may take place via a shuttle valve 26 in the extraction line and an LH2 inlet line 20 into the primary inner tank 1.

The two supply lines 4 of the primary secondary storage system and the secondary storage system may be combined at an extraction connection 28, preferentially downstream of the check valves 12, in order to supply the consumer 5 with the stored medium through a common supply line.

Should the pressure in the primary inner tank of the primary storage system be less than the pressure in the secondary inner tank of the secondary storage system, a hydraulic equilibrating flow may take place through the connecting line 27 by opening the check valves 25. This equilibrating flow transfers fuel from the secondary storage system to the primary storage system until the pressures have equilibrated or the check valves 25 interrupt the flow path.

Should the pressures be equilibrated between the primary secondary storage system and the secondary storage system, and there is a need to increase or maintain the pressure in the primary inner tank 1 of the primary storage system, gas may be transferred back into the primary inner tank 1 via a valve 13 in a gas return line 6, which branches off at the line connection 3 from the extraction line downstream of the heat exchanger 7. In order to limit the pressure for the gas return into the primary inner tank 1, a pressure reducer 9 with a downstream pressure safety valve 10 may if required be installed in the gas return line 6.

The secondary storage system 30 comprises substantially the same components as the primary storage system, although no cryopump is arranged in the secondary storage system. The matching components are represented in the secondary storage system 30 at the same positions of the cryotank of the secondary storage system 30 as they correspondingly have in the primary storage system.

At least one or more components which are provided for the pressure increase, extraction and/or conditioning of the hydrogen in the primary storage system, namely components in the region which is indicated by a dashed rectangle in the Fig., may optionally also be omitted in the secondary storage system, i.e. not installed. In particular, the secondary storage system may comprise no extraction line and/or no heat exchanger and/or no pressure reducer and/or no pressure safety valve and/or no check valve in the extraction line.

The terms “coupled,” “attached,” or “connected” may be used herein to refer to any type of relationship, direct or indirect, between the components in question, and may apply to electrical, mechanical, fluid, thermal, optical, electromagnetic, electromechanical, or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 primary inner tank of the primary storage system
2 primary outer container
3 line connection
4 supply line
5 consumer
6 gas return line
7 heat exchanger
8 buffer container
9 pressure reducer
10 pressure safety valve
11 cooling water circuit
12 check valve for H₂ supply to the consumer
13 check valve for gas return to the inner tank
14 interface for filling
15 GH₂ tank valve
16 LH₂ tank valve
17 nonreturn valve for the gas extraction
18 combined safety and gas extraction line
19 pressure relief safety valve
20 LH₂ inlet line into the inner tank
21 cryopump(s)
22 pressure line of the cryopump
23 check valve near to the pump for switching from LH2 to GH2
24 gas extraction line as extended intake port of the cryopump
25 check valve, near to the tanks, of the connecting line
26 shuttle valve
27 connecting line between primary and secondary storage systems
28 extraction connection between primary storage system and secondary storage system
30 secondary storage system

1. A multi-cryostorage system, comprising:
at least two cryocontainers for storing hydrogen, the at least two cryocontainers being connected in hydraulic communication via a cryogenic connecting line, the at least two cryocontainers including a primary storage system having a primary inner tank and a primary outer container, and at least one secondary storage system having a secondary inner tank and a secondary outer container;
a heat exchanger operable to heat the hydrogen; and
at least one cryopump, arranged in the primary inner tank, to supply unpressurised liquid hydrogen and/or unpressurised gaseous hydrogen in one or more stages at low temperature, to the heat exchanger for delivery to a consumer at a pressure higher than the pressure in the primary inner tank.

2. The multi-cryostorage system of claim 1, wherein the at least one cryopump is fully surrounded by cryogenic fluid during normal operation and/or a cryopump drive of the at least one cryopump is configured to work at low temperatures.

3. The multi-cryostorage system of claim 1, wherein:
the cryogenic connecting line has at least two check valves adjacent to the primary inner tank and the secondary inner tank, and
in response to a leak, the at least two check valves are adapted to allow hydraulic pressure equilibration and close a connection between the two the primary inner tank and the secondary inner tank via the cryogenic connecting line.

4. The multi-cryostorage system of claim 3, wherein the cryogenic connecting line only has, downstream of the at least check valves, line ends which are routed in a region of a respective one of the primary inner tank and the secondary inner tank to a bottom thereof.

5. The multi-cryostorage system of claim 4, wherein the cryogenic connecting line is independent of extraction devices of the at least two cryocontainers.

6. The multi-cryostorage system of claim 1, wherein the primary storage system is operable to return a partial flow of warmed hydrogen that is extracted downstream of the heat exchanger, via a return line into the primary inner tank in order to increase pressure in the primary inner tank.

7. The multi-cryostorage system of claim 6, further comprising a pressure reducer having a downstream pressure safety valve, arranged in the return line for return of the gas to the primary inner tank.

8. The multi-cryostorage system of claim 1, further comprising a buffer container for warm hydrogen arranged between the at least one cryopump and the consumer.

9. The multi-cryostorage system of claim 1, wherein:
the primary storage system is fillable via a primary storage system filling interface, and
the secondary storage system is fillable via a secondary storage system filling interface.

10. The multi-cryostorage system of claim 1, wherein the primary storage system and the secondary storage system are separately fillable via respective filling interfaces.

11. The multi-cryostorage system of claim 1, wherein the secondary storage system lacks a cryopump.

12. The multi-cryostorage system of claim 1, wherein the secondary storage system comprises substantially the same components as the primary storage system, with an exception of having no cryopump.

13. A multi-cryostorage system, comprising:
at least two cryocontainers for storing hydrogen, the at least two cryocontainers being connected in hydraulic communication via a cryogenic connecting line, the at least two cryocontainers including a primary storage system having a primary inner tank and a primary outer container, and at least one secondary storage system having a secondary inner tank and a secondary outer container;
a heat exchanger operable to heat the hydrogen; and
at least one cryopump, arranged in the primary inner tank, to supply pressurized liquid hydrogen and/or pressurized gaseous hydrogen in one or more stages at low temperature, to the heat exchanger for delivery to a consumer at a pressure higher than the pressure in the primary inner tank.

14. The multi-cryostorage system of claim 13, wherein the at least one cryopump is fully surrounded by cryogenic fluid during normal operation and/or a cryopump drive of the at least one cryopump is configured to work at low temperatures.

15. The multi-cryostorage system of claim 13, wherein:
the cryogenic connecting line has at least two check valves adjacent to the primary inner tank and the secondary inner tank, and
in response to a leak, the at least two check valves are adapted to allow hydraulic pressure equilibration and close a connection between the two the primary inner tank and the secondary inner tank via the cryogenic connecting line.

16. The multi-cryostorage system of claim 15, wherein the cryogenic connecting line only has, downstream of the at least check valves, line ends which are routed in a region of a respective one of the primary inner tank and the secondary inner tank to a bottom thereof.

17. The multi-cryostorage system of claim 16, wherein the cryogenic connecting line is independent of extraction devices of the at least two cryocontainers.

18. The multi-cryostorage system of claim 13, wherein the primary storage system is operable to return a partial flow of heated hydrogen that is extracted downstream of the heat exchanger, via a return line into the primary inner tank in order to increase pressure in the primary inner tank.

19. The multi-cryostorage system of claim 17, further comprising a pressure reducer having a downstream pressure safety valve, arranged in the return line for return of the gas to the primary inner tank.

20. The multi-cryostorage system of claim 13, further comprising a buffer container for warm hydrogen arranged between the at least one cryopump and the consumer.

21. The multi-cryostorage system of claim 13, wherein:
the primary storage system is fillable via a primary storage system filling interface, and
the secondary storage system is fillable via a secondary storage system filling interface.
